(19) United States
(12) Patent Application Publication
(10) Pub. No.: US 2004/0090026 A1
(43) Pub. Date: May 13, 2004

(54) Ski equipment tote

(76) Inventor: William T. Ball, Colorado Springs, CO (US)

Correspondence Address: ZARLEY LAW FIRM P.L.C., CAPITAL SQUARE, 400 LOCUST, SUITE 200, DES MOINES, IA, 50309-2350, US

(21) Appl. No.: 10/290,778

(22) Filed: Nov. 8, 2002

(51) Int. Cl. B62B 1/00

(52) U.S. Cl. 280/47.26

(57) ABSTRACT

A transporting assembly having a housing with an open end, an opposite closed end, and a sidewall for receiving ski equipment that is mounted on wheels where a swing door is pivotally connected to the housing and can be secured to the housing.

### BACKGROUND OF THE INVENTION

This invention relates generally to a transporting and storage device and more particularly to a device for transporting and storing ski equipment.

Transporting ski equipment from a vehicle, residence, or hotel can be a heavy, awkward, inconvenient, and cumbersome task. Some skiers carry skis and ski poles on their shoulders, in an upright position, or under their arms, while they maneuver stairs and pathways that are often snow and ice covered. Not only is this tiring, but it is also somewhat dangerous if the skier is wearing ski boots as ski boots do not have exceptional traction, which might result in a fall and injury. To reduce some of this risk, some skiers will carry their ski boots separately and wear street shoes to and from the slopes. While this reduces the risk of injury, this method also requires that a skier find a locker at the slope to store the street shoes while skiing.

To overcome these problems, carriers have been developed for transporting ski equipment. Such carriers allow a skier to more conveniently carry all the equipment at once to and from slopes. Examples of such carriers can be found in U.S. Pat. Nos. 4,358,137 and 4,856,811. These patents, however, disclose further problems. Particularly, a skier must dispose of the carrier in a locker.

In view of these problems, it is desirable to provide a transporting device that can be secured to a conventional ski rack available at most ski slopes, as well as provide a secured storage compartment for storing equipment such as street shoes and the like.

Thus, a principal objective of the invention is to provide a device that enables a skier to easily transport ski equipment to and from a ski slope.

A further objective is to provide a device that allows a skier to conveniently store and secure equipment at a ski slope.

Another objective is to provide a device that can be secured to any type of conventional rack at a ski slope.

A still further objective is to provide a device that allows a skier to store equipment in an upright position.

Various other objects, advantages, and features of the invention will become apparent to those skilled in the art from a reading of the disclosure.

### BRIEF SUMMARY OF THE INVENTION

The transporting assembly has a housing with an open end, an opposite closed end, and a sidewall for receiving ski equipment that is mounted on wheels. Pivotally connected to the open end of the housing is a swing door that can be moved from an open position to a closed position and secured to the housing when in a closed position.

### BRIEF DESCRIPTION OF THE DRAWINGS

FIG. 1 is a perspective view of the invention;

FIG. 2 is a side view of the invention;

FIG. 3 is a side view of the invention with a swing door; and

FIG. 4 is a side view of the invention with a notched housing.

### DESCRIPTION OF THE PREFERRED EMBODIMENTS

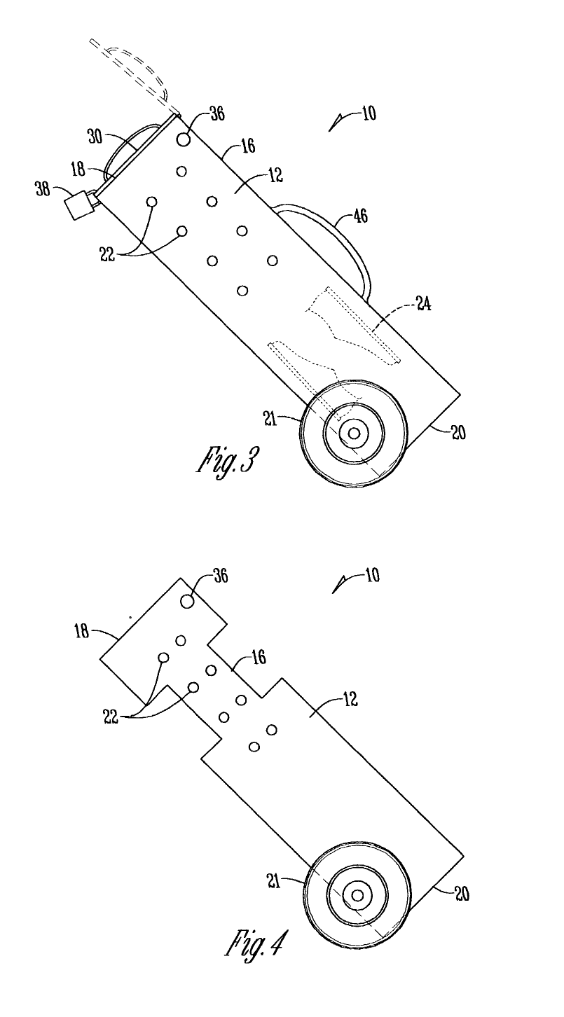

The transporting device of this invention is generally referred to in the drawings by reference numeral 10. The device has a housing 12 for receiving ski equipment 14 with sidewall 16, an open end 18 and a closed end 20. The housing 12 can be of any shape and size but it is preferred that the sidewall 16 be generally cylindrical. The housing can be of a size that snuggly receives skis, or in another embodiment, as shown in FIG. 3, large enough to receive street shoes 24 or ski boots. In another embodiment, as shown in FIG. 4, the sidewalls 16 of the housing 12 are notched to fit any conventional ski rack.

A plurality of holes 22 that are positioned in opposite relation on the sidewall 16 of the housing are used to assist in securing the skis within the housing. A pair of cords 26, such as bungee cords, are connected to holes 22 and extend around the front part of the bindings 14A of the skis 14 and is connected to a hole on the opposite side of the sidewall 16 to secure the ski equipment 14 within the housing 12.

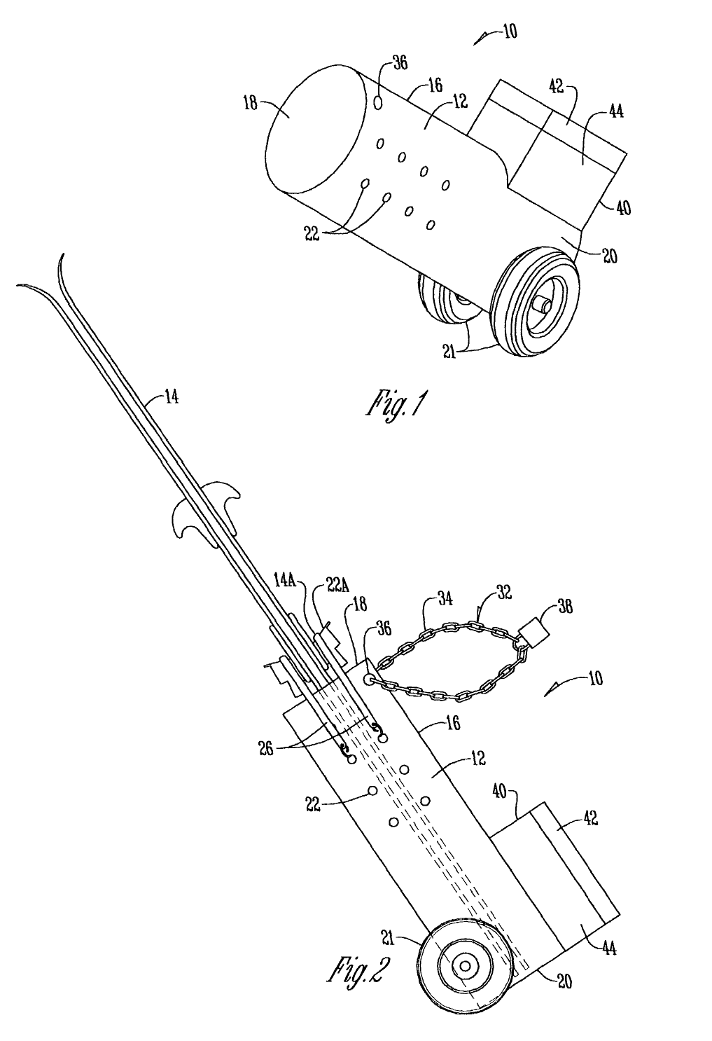

The housing 12 is mounted on any conventional means for transporting the device such as a pair of wheels 21 or the like as shown in FIG. 1.

Pivotally connected to the open end 18 of the housing 12 is a swing door 30 that can be moved from an open position that allows access to the housing, to a closed position where the open end is covered as shown in FIG. 3. In this embodiment, a locking device such as a padlock 38 can secure the swing door 30 to the housing 12 when the swing door is in a closed position. See FIG. 3. As a result, a skier could place walking shoes in the housing 12 of the device 10 and lock the swing door 30 to protect against theft.

The device 10 is secured to a conventional ski rack with a locking means 32. (FIG. 2) While a number of different means can be used to secure the device 10 to a ski rack, preferred is the use of a chain or cord 34 that extends through a hole 36 located on the sidewall 16 of the housing 12 and around the ski rack and the opposite ends of the chain are secured with a padlock 38. In an alternative embodiment, the chain 34 can extend through oppositely disposed holes 36 and around the ski rack allowing a skier to hang the device 10 from the ski rack.

In one embodiment, attached to the housing 12 is a lock box 40 as shown in FIGS. 1 and 2. The lock box, which has a top 42 pivotally connected to the bottom portion 44, allows a skier to store ski boots in the lock box while transporting the device, or storing walking shoes while skiing. The top 42 can be secured to the bottom 44 by a conventional means.

To assist in carrying and maneuvering the device, a handle 46 can be placed on the housing 12 or on the swing door 30. (FIG. 3) In addition, the plane of the closed end 20 of the housing is flush with the outer periphery of the wheels 21 to enable the device to stand on end for vertical storage of the ski equipment. This reduces the need for a storage rack at one's residence as well as the possibility of the ski edges damaging or marking a wall.

As can be seen from the foregoing disclosure, the device provides an easy means for transporting ski equipment where equipment can be stored and secured within the device as well as to a ski rack.

It will be appreciated by those skilled in the art that other various modifications could be made to the device without departing from the spirit and scope of this invention. All such modifications and changes fall within the scope of the claims are intended to be covered thereby.

What is claimed is:

1. A device for transporting ski equipment to a ski slope with a ski rack comprising:
a housing for receiving ski equipment having sidewalls, an open end, and an opposite closed end mounted on a means for transporting the device; and
a swing door pivotally connected to the housing and positioned to cover the open end of the housing when the swing door is in a closed position.

2. The device of claim 1 further comprising a locking means for securing the swing door in a closed position.

3. The device of claim 1 wherein the housing has a means for securing ski equipment when received in the housing.

4. The device of claim 3 wherein the means for securing the ski equipment comprises a plurality of holes in the sidewalls of the housing and a securing member that is attached to one hole and extends around the ski equipment and at least partially around the housing where it is connected to the housing at the opposite end of the securing member.

5. The device of claim 1 further comprising a locking means for securing the device to the ski rack.

6. The device of claim 1 wherein the housing has a notch between the open end and the closed end for placement upon an automobile ski rack.

7. The device of claim 1 wherein at least one handle is connected to the housing.

8. A device for transporting ski equipment to a ski slope with a ski rack comprising:
a housing for receiving the ski equipment having sidewalls, an open end and an opposite closed end mounted on a means for transporting the device; and
a storage container connected to a sidewall of the housing.

9. The device of claim 8 wherein the housing has a means for securing ski equipment when received in the housing.

10. The device of claim 9 wherein the means for securing the ski equipment comprises a plurality of holes in the sidewalls of the housing and a securing member that is attached to one hole and extends around the ski equipment and at least partially around the housing where it is connected to the housing at the opposite end of the securing member.

11. The device of claim 8 further comprising a locking means for securing the device to the ski rack.

12. The device of claim 8 wherein the housing has a notch between the open end and the closed end.

13. The device of claim 8 wherein at least one handle is connected to the housing.
